(19) United States
(12) Patent Application Publication
(10) Pub. No.: US 2021/0075221 A1
(43) Pub. Date: Mar. 11, 2021

(54) REAL TIME ENERGY MANAGEMENT AND CONTROL OF RENEWABLE ENERGY BASED MICROGRID IN GRID-CONNECTED AND ISLAND MODES

(71) Applicant: KING FAHD UNIVERSITY OF PETROLEUM AND MINERALS, Dhahran (SA)

(72) Inventors: Muhammed Y. WORKU, Dhahran (SA); Mohamed A. HASSAN, Dhahran (SA); Mohamed A. ABIDO, Dhahran (SA)

(73) Assignee: KING FAHD UNIVERSITY OF PETROLEUM AND MINERALS, Dhahran (SA)

(21) Appl. No.: 16/562,613

(22) Filed: Sep. 6, 2019

(51) Int. Cl. H02J 3/38; H02J 3/32; G05B 9/03

(52) U.S. Cl. CPC H02J 3/385; H02J 3/32; H02M 7/53871; H02J 2003/388; G05B 9/03

(57) ABSTRACT

A system for efficient power management control includes a microgrid, a primary electrical grid, a first control unit, a second control unit, and a third control unit. The microgrid, which is an active load based microgrid, is electrically coupled with the primary electrical grid in grid-connected mode and includes at least one photovoltaic (PV) array, at least one battery, and at least one generator. The first control unit is used to manage the at least one PV array. The second control unit is used to manage the at least one battery. The third control unit is used to control the at least one generator. In grid-connected mode, a system frequency and voltage supplied to the active load is regulated by the primary electrical grid. During a fault in island mode, the at least one generator controls the system frequency and voltage.

### STATEMENT OF ACKNOWLEDGEMENT

This project was supported by the Deanship of Scientific Research, King Fahd University of Petroleum and Minerals, through Electrical Power and Energy Systems Research Group Funded Project #RG171002.

### STATEMENT OF PRIOR DISCLOSURE BY THE INVENTORS

Aspects of the present disclosure are described in Worku, M., Hassan, M. and Abido, M. (2019). Real Time Energy Management and Control of Renewable Energy based Microgrid in Grid Connected and Island Modes, Energies, Volume 12—Issue 2, Jan. 16, 2019, https://doi.org/10.3390/en12020276, incorporated herein by reference in their entirety.

### BACKGROUND

### Field of the Invention

The present disclosure is generally related to a power management control system and method for microgrids with energy storage, and a grid including electrical generators such as photovoltaic and hydrocarbon combustion, in combination with electrical storage such as battery. In particular, the system described in the present disclosure increases the reliability and resiliency of a microgrid, wherein the microgrid is based on local active loads with three distributed energy resources (DERs), namely a photovoltaic (PV) array, a battery, and a diesel generator.

### Description of the Related Art

A microgrid is a small scale power grid composed of distributed generation (DG), energy storage and loads accumulated together in the vicinity of each other. See Parhizi, S.; Lotfi, H.; Khodaei, A.; Bahramirad, S. State of the Art in Research on Microgrids: A Review. IEEE Access 2015, 3; and Guerrero, J. M.; Loh, P. C.; Lee, T. L.; Chandorkar, M. Advanced Control Architectures for Intelligent Microgrids—Part II: Power Quality, Energy Storage, and AC/DC Microgrids. IEEE Trans. Ind. Electron. 2013, 60, 1263-1270, each incorporated herein by reference in their entirety. Microgrids increase the resiliency and reliability of microgrids during severe weather conditions and emergency events. Microgrids offer several advantages and benefits including improvements in energy efficiency, reduced power transmission losses (e.g., the distributed energy resources (DERs) are located nearby to the load), reduction in CO₂ emissions, integration of renewable and alternative energy sources, energy access to remote and developing communities, grid support functions, such as voltage regulation in low and medium voltage distribution networks, and other environmental benefits. See Xia, Y.; Wei, W.; Yu, M.; Wang, X.; Peng, Y. Power Management for a Hybrid AC/DC Microgrid with Multiple Subgrids. IEEE Trans. Power Electron. 2018, 33, 3520-3533; Radwan, A. A. A.; Mohamed, Y. A. R. I. Networked Control and Power Management of AC/DC Hybrid Microgrids. IEEE Syst. J. 2017, 11, 1662-1673; Sahoo, S. K.; Sinha, A. K.; Kishore, N. K. Control Techniques in AC, DC, and Hybrid AC-DC Microgrid: A Review. IEEE J. Emerg. Sel. Top. Power Electron. 2018, 6, 738-759; M, J.; Wang, Y.; Wang, C.; Wang, H. Design and implementation of hardware-in the-loop simulation system for testing control and operation of DC microgrid with multiple distributed generation units. IET Gener. Transm. Distrib. 2016, 11, 3065-3072; and Li, Z.; Shahidehpour, M.; Aminifar, F.; Alabdulwahab, A.; Al-Turki, Y. Networked Microgrids for Enhancing the Power System Resilience. Proc. IEEE 2017, 105, 1289-1310, each incorporated herein by reference in their entirety.

A microgrid can be operated in parallel with a main utility (grid-connected mode) or independently as a power island (island mode) and can be AC, DC, or a combination of both DC and AC (hybrid). See Jap, L.; Moreira, C. L.; Madureira, A. G. Defining Control Strategies for MicroGrids Islanded Operation. IEEE Trans. Power Syst. 2006, 21, 916-924; Che, L.; Shahidehpour, M.; Alabdulwahab, A.; Al-Turki, Y. Hierarchical Coordination of a Community Microgrid with AC and DC Microgrids. IEEE Trans. Smart Grid 2015, 6, 3042-3051, each incorporated herein by reference in their entirety. In grid-connected mode, microgrids support the main grid with voltage control, frequency control, and can provide more flexibility and reliability by exchanging power based on supply and demand. In this mode, DERs operate in a maximum power point tracking (MPPT) mode and deliver maximum power to the grid. In island mode, the microgrid disconnects itself from the main grid and supplies the load from the DERs. See Nutkani, I. U.; Meegahapola, L.; Andrew, L. P. C.; Blaabjerg, F. Autonomous Power Management for Interlinked AC-DC Microgrids. CSEE J. Power Energy Syst. 2018, 4, 11-18; and Peyghami, S.; Mokhtari, H.; Blaabjerg, F. Autonomous Power Management in LVDC Microgrids Based on a Superimposed Frequency Droop. IEEE Trans. Power Electron. 2018, 33, 5341-5350, each incorporated herein by reference in their entirety. In both operation modes, the balance between power demand and supply is one of the most important criteria in managing the microgrid. In grid-connected mode, the main grid is required to meet the balance. However, in the island mode the microgrid needs to do the balancing via increases in generation or load sharing. See Xin, H.; Zhang, L.; Wang, Z.; Gan, D.; Wong, K. P. Control of Island AC Microgrids Using a Fully Distributed Approach. IEEE Trans. Smart Grid 2015, 6, 943-945; Hassan, M. A.; Worku, M. Y.; Abido, M. A. Optimal Design and Real Time Implementation of Autonomous Microgrid Including Active Load. Energies 2018, 11, 1109; Dhua, R.; Chatterjee, D.; Goswami, S. K. Study of Improved Load Sharing Methodologies for Distributed Generation Units Connected in a Microgrid. CSEE J. Power Energy Syst. 2017, 3, 311-320; and Han, H.; Hou, X.; Yang, J.; Wu, J.; Su, M.; Guerrero, J. M. Review of Power Sharing Control Strategies for Islanding Operation of AC Microgrids. IEEE Trans. Smart Grid 2016, 7, 200-215, each incorporated herein by reference in their entirety.

A hybrid microgrid power supply system based on a combination of wind, photovoltaic (PV), fuel cell (FC) along with the dynamic operation and control strategies is presented in Ou et al., Ma et al., and Sharma et al. See Ou, T.; Hong, C. Dynamic operation and control of microgrid hybrid power systems. Energy 2014, 66, 314-323; Ma, T.; Cintuglu, M. H.; Mohammed, O. A. Control of a hybrid AC/DC microgrid involving energy storage and pulsed loads. IEEE Trans. Ind. Appl. 2017, 53, 567-575; and Sharma, R. K.; Mishra, S. Dynamic Power Management and Control of a PV PEM Fuel-Cell-Based Standalone ac/dc Microgrid Using Hybrid Energy Storage. IEEE Trans. Ind. Appl. 2018, 54, 526-538, each incorporated herein by reference in their entirety. A static var compensator was used for reactive power control and to regulate system voltage. A distributed model predictive control (MPC) for dispatching the power of a microgrid consisting of DGs, storage and shiftable loads was proposed in Zheng et al. See Zheng, Y.; Li, S.; Tan, R. Distributed Model Predictive Control for On-Connected Microgrid Power Management. IEEE Trans. Control Syst. Technol. 2018, 26, 1028-1039, incorporated herein by reference in its entirety. Power management control for microgrids with distributed generation was discussed in Katiraei et al., Nejabatkhah et al., Eghtedarpour et al., and Sun et al. See Katiraei, F.; Iravani, M. R. Power Management Strategies for a Microgrid with Multiple Distributed Generation Units. IEEE Trans. Power Syst. 2006, 21, 1821-1831; Nejabatkhah, F.; Li, Y. W. Overview of Power Management Strategies of Hybrid AC/DC Microgrid. IEEE Trans. Power Electron. 2015, 30, 7072-7089; Eghtedarpour, N.; Farjah, E. Power Control and Management in a Hybrid AC/DC Microgrid. IEEE Trans. Smart Grid 2014, 5, 1494-1505; and Sun, Q.; Zhou, J.; Guerrero, J. M.; Zhang, H. Hybrid Three-Phase/Single-Phase Microgrid Architecture with Power Management Capabilities. IEEE Trans. Power Electron. 2015, 30, 5964-5977, each incorporated herein by reference in their entirety. These disclosures describe a frequency-droop characteristic to control real power, and for reactive power control they disclose voltage-droop characteristics, voltage regulation and load reactive power compensation. However, the fluctuation in the output of DERs with renewable energy resources (photovoltaic or wind) and varying load demands pose challenges to the successful operation of microgrids. Energy storage devices such as flywheels, batteries and supercapacitors could be used to minimize the fluctuation in renewable sources and assist the DERs match generation with demand. See Worku, M. Y.; Abido, M. A.; Iravani, R. Power Fluctuation Minimization in Grid Connected PV Using Supercapacitor Energy Storage System. J. Renew. Sustain. Energy 2016, 8, 013501; Jia, K.; Chen, Y.; Bi, T.; Lin, Y.; Thomas, D.; Sumner, M. Historical-Data-Based Energy Management in a Microgrid With a Hybrid Energy Storage System. IEEE Trans. Ind. Inform. 2017, 13, 2597-2605; Tan, X. G.; Li, Q. M.; Wang, H. Advances and trends of energy storage technology in micro-grid. Int. J. Electr. Power Energy Syst. 2013, 44, 179-191; Hill, C. A.; Such, M. C.; Chen, D.; Gonzalez, J.; Grady, W. M. Battery Energy Storage for Enabling Integration of Distributed Solar Power Generation. IEEE Trans. Smart Grid 2012, 3, 850-857; and Worku, M. Y.; Abido, M. A. Fault Ride-Through and Power Smoothing Control of PMSG-Based Wind Generation Using Supercapacitor Energy Storage System. Arab. J. Sci. Eng. 2018, each incorporated herein by reference in their entirety. A supervisory power management system with reduced number of sensors for a grid interactive microgrid with a hybrid energy storage system is proposed in Kotra et al. and Korad et al. See Kotra, S.; Mishra, M. K. A Supervisory Power Management System for a Hybrid Microgrid with HESS. IEEE Trans. Ind. Electron. 2017, 64, 3640-3649; Korad, N.; Mishra, M. K. Grid Adaptive Power Management Strategy for an Integrated Microgrid with Hybrid Energy Storage. IEEE Trans. Ind. Electron. 2017, 64, 2884-2892, each incorporated herein by reference in their entirety. Energy management and effective control techniques for a photovoltaic-based DC microgrid is proposed in Kumar et al. See Kumar, M.; Srivastava, S. C.; Singh, S. N. Control strategies of a DC microgrid for grid connected and islanded operations. IEEE Trans. Smart Grid 2015, 6, 1588-1601, incorporated herein by reference in its entirety.

A control technique based on the inherent characteristics of synchronous generators (SG) for control of interfaced converters with high penetration of renewable energy resources (RERs) into the power grid was presented in Mehrasa et al. See Mehrasa, M.; Pouresmaeil, E.; Sepehr, A.; Pournazarian, B.; Marzband, M.; Catalão, J. P. S. Control technique for the operation of grid-tied converters with high penetration of renewable energy resources. Electr. Power Syst. Res. 2019, 166, 18-28, incorporated herein by reference in its entirety. A multi-stage stochastic programming for smart transactive energy (TE) framework in which home microgrids (H-MGs) collaborate with each other in a multiple H-MG system by forming coalitions for gaining competitiveness in the market was discussed in Marzband et al. See Marzband, M.; Azarinejadian, F.; Savaghebi, M.; Pouresmaeil, E.; Guerrero, J. M.; Lightbody, G. Smart transactive energy framework in grid-connected multiple home microgrids under independent and coalition operations. Renew. Energy 2018, 126, 95-106, incorporated herein by reference in its entirety. Marzband et al. describe an optimization-based algorithm in the regulation of electricity market within the context of economic planning and control for grid reliability enhancement. See Marzband, M.; Fouladfar, M. H.; Akorede, M. F.; Lightbody, G.; Pouresmaeil, E. Framework for smart transactive energy in home-microgrids considering coalition formation and demand side management. Sustain. Cities Soc. 2018, 40, 136-154, incorporated herein by reference in its entirety. A battery energy storage management system of to enhance the resilience of the photovoltaic-based microgrid supplying a typical commercial building while maintaining its operational cost at a minimum level was proposed in Tavakoli et al. See Tavakoli, M.; Shokridehaki, F.; Akorede, M. F.; Marzband, M.; Vechiu, I.; Pouresmaeil, E. CVaR-based energy management scheme for optimal resilience and operational cost in commercial building microgrids. Electr. Power Energy Syst. 2018, 100, 1-9, incorporated herein by reference in its entirety. Improvement is achieved by solving a linear optimization programming problem while the Conditional Value at Risk (CVaR) is incorporated in the objective function. The CVaR is used to account for the uncertainty in the intermittent PV system generated power and that in the electricity price. A power management strategy for an island mode microgrid with multiple decentralized batteries, PV, and droop units, is employed in Mahmood et al. and Karimi et al. See Mahmood, H.; Jiang, J. Decentralized Power Management of Multiple PV, Battery, and Droop Units in an Islanded Microgrid. IEEE Trans. Smart Grid 2018; and Karimi, Y.; Oraee, H.; Guerrero, J. M. Decentralized Method for Load Sharing and Power Management in a Hybrid Single/Three-Phase-Islanded Microgrid Consisting of Hybrid Source PV/Battery Units, IEEE Trans. Power Electron. 2017, 32, 6135-6144, each incorporated herein by reference in their entirety. Energy storage can help the system ride-through the fault, provide generation deficiencies, reduce load surges, reduce network losses and improve the protection system by contributing to fault currents. Hence, it is important to coordinate between DGs and energy storage devices. The fault ride-through enhancement with energy storage, coordination between DGs and energy storage devices during grid connected and island modes, and the transient response of the microgrid are relatively unknown.

Accordingly, it is one object of the present disclosure to provide an efficient power management control system and method for microgrids with energy storage. The system and method are especially applicable to microgrids based on a PV array, a battery, and a diesel generator operating with local active loads with the PV array and the battery controls preferably based on the decoupled d-q current control strategy.

It is another object of the present disclosure to provide a controller that, during grid-connected mode, supplies operating power to a load by DERs and a grid. Preferably the PV array generates the maximum available power using a maximum power point tracking tool to supply the load, and the excess power is transferred to the grid. In island mode, the operating power to the load is supplied by the DERs and if the power generated from the PV array decreases, the diesel generator provides the power balance. During normal operation and fault, the diesel generator controls the frequency and voltage in isochronous mode. The power storage in the battery minimizes the fluctuation and helps the microgrid ride-through the fault. Details further describing the system configuration, the proposed controller, and the results obtained by using the system of the present disclosure are also disclosed herein.

### SUMMARY OF THE INVENTION

The system of the present disclosure that includes or consists of a microgrid and a primary electrical grid which are electrically connected to each other. The microgrid, which is based upon an active load, comprises a photovoltaic (PV) array, a battery, and a generator. Each component of the microgrid is connected to the primary electric grid at a point of common coupling through a corresponding circuit breaker. The primary electric grid is also connected to the microgrid at the point of common coupling through a grid circuit breaker. Furthermore, the PV array is electrically connected to the primary electrical grid through a first control unit that comprises a buck converter and a voltage source converter (VSC). The battery is electrically connected to the primary electrical grid through a second control unit that comprises a second VSC. The generator is electrically connected to the primary electrical grid through a third control unit that comprises a speed governing unit.

During grid-connected mode under normal operational conditions, the microgrid is connected to the primary electrical grid, and the power required by the load is supplied by the distributed energy resources (DERs), namely the PV array, the battery, and the generator, and the primary electrical grid. The voltage and frequency during grid-connected mode under normal conditions, where the load demand is matched by the production, is maintained at the rated values of the primary electrical grid. In island mode, the power for the load is supplied by the DERs, and the voltage and the frequency are controlled by the diesel generator in isochronous mode. More specifically, in isochronous speed control mode, the speed will return to the original speed set point after the load has been applied or rejected and is used when a generator is operating independently and is used to maintain the frequency at 60-Hertz (Hz).

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an illustration of the distributed energy resources (DERs) based microgrid and the primary electrical grid used in the system described in the present disclosure.

FIG. 2 is a circuit diagram illustrating the buck converter of the first control unit used for maximum power point tracking (MPPT).

FIG. 3 is a circuit diagram illustrating the first voltage source converter of the first control unit of the PV array.

FIG. 4 is a circuit diagram illustrating a decoupled P-Q inverter control.

FIG. 5 is a circuit diagram of a battery grid-connected decoupled controller.

FIG. 6 is a circuit diagram illustrating the electrical connections of a diesel generator, exciter, and a speed governor.

FIG. 7 is an electrical diagram associated with the speed governor controller of the diesel generator.

FIG. 8 is a simulation result obtained for the DERs within the system of the present disclosure.

FIG. 9 is a graph illustrating the primary electrical grid power, PV array output power, battery power, generator power, and load power in grid-connected mode.

FIG. 10 is a graph illustrating the corresponding grid voltage and breaker currents in grid-connected mode.

FIG. 11 is a graph illustrating the state of charge of the battery in grid-connected mode.

FIG. 12 is a graph illustrating the power from the primary electrical grid, the output power from the PV array, the output power from the battery, the generated power form the generator, and the load power when the battery discharges.

FIG. 13 is a graph illustrating the power from the primary electrical grid, the output from the PV array, the output power from the battery, the generated power from the generator, and the load power, wherein the primary electrical grid power increases to accommodate load power increase.

FIG. 14 is a graph illustrating the power from the primary electrical grid, the output from the PV array, the output power from the battery, the generated power from the generator, and the load power, wherein the irradiation increases and the primary electrical grid power decreases.

FIG. 15 is a graph illustrating the power from the primary electrical grid, the output from the PV array, the output power from the battery, the generated power from the generator, and the load power in island mode.

FIG. 16 is a graph illustrating the corresponding point of common coupling (PCC) voltage in island mode.

FIG. 17 is a graph illustrating the power from the primary electrical grid, the output from the PV array, the output power from the battery, the generated power from the generator, and the load power, wherein the PV array irradiation decreases and power from the generator increases to accommodate the difference in power.

FIG. 18 is a graph illustrating the power from the primary electrical grid, the output from the PV array, the output power from the battery, the generated power from the generator, and the load power, wherein the battery discharges and the power from the generator also decreases.

FIG. 19 is a graph illustrating the PCC per unit voltage during fault in grid-connected mode.

FIG. 20 is a graph illustrating the power from the primary electrical grid, the output from the PV array, the output power from the battery, the generated power from the generator, and the load power during fault in grid-connected mode.

FIG. 21 is a graph illustrating the PCC per unit voltage during fault in island mode.

FIG. 22 is a graph illustrating the power from the primary electrical grid, the output from the PV array, the output power from the battery, the generated power from the generator, and the load power during fault in island mode.

### DETAILED DESCRIPTION

All illustrations of the drawings are for the purpose of describing selected embodiments of the present disclosure and are not intended to limit the scope of the present disclosure or accompanying claims.

The system and method of the present disclosure include a power management control for microgrids with energy storage capabilities. By implementing the system of the present disclosure, the reliability and resiliency of a microgrid can be increased, wherein the microgrid is based upon at least three distributed energy resources (DERs), at least one photovoltaic (PV) array, at least one battery, and at least one generator with locally active loads.

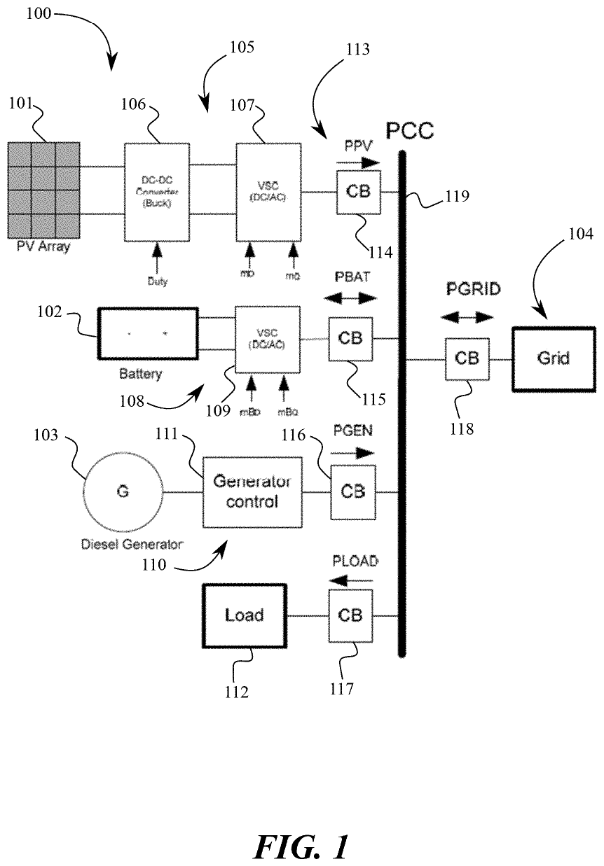

As illustrated in FIG. 1, in order to fulfill the intended functionalities, the power management and control system/method for an electric grid comprises a microgrid 100, a primary electrical grid 104, a first control unit 105, a second control unit 108, and a third control unit 110. The microgrid 100, which is an active load 112 based microgrid, and the primary electrical grid 104 are electrically coupled at a point of common coupling (PCC) 119, wherein the PCC 119 is a point of a power supply network, electrically nearest to the active load 112, at which other loads are, or may be, connected. The microgrid 100 comprises at least one photovoltaic (PV) array 101, at least one battery 102, and at least one generator 103 wherein the coordination and electrical coupling between the at least one PV array 101, the at least one battery 102, and the at least one generator 103 are advantageous for microgrid management. In order to fulfill a power demand of the active load 112, the microgrid 100 and the primary electrical grid 104 are electrically connected to the active load in a grid-connected mode. On the other hand, when the microgrid 100 is in an island mode, the power demand of the active load 112 is supplied by only by the microgrid 100 that is electrically connected to the active load 112.

The at least one PV array 101 is designed to supply usable solar power by means of photovoltaics, wherein PV cells are connected electrically in series and/or parallel circuits to produce higher voltages, currents, and power levels. PV modules include PV cell circuits sealed in an environmentally protective laminate, and are the fundamental building blocks of PV systems. Photovoltaic panels include one or more PV modules assembled as a pre-wired, field-installable unit. A PV array is the complete power-generating unit, including any number of PV modules and panels. The number of PV modules used within the at least one PV array 101 of the system of the present disclosure can vary. In a preferred embodiment of the system, standard conditions are assumed for the at least one PV array 101. In particular, a PV module operating temperature of 25-Centigrade (° C.) and an incident solar radiance level of 1000 Watt/Square meter (W/m²) under air mass 1.5 spectral distribution is assumed. However, different values can also be used in other embodiments of the system in the present disclosure.

Preferably, a grid-connected PV array is used wherein the at least one PV array 101 is designed to operate in parallel with and interconnected with the primary electrical grid 104. The primary component in grid-connected PV array is the inverter, or power conditioning unit (PCU). The PCU converts the direct current (DC) power produced by the at least one PV array 101 into alternating current (AC) power consistent with the voltage and power quality requirements of the primary electrical grid 104, and automatically stops supplying power to the microgrid 100 when the primary electrical grid 104 is not energized. A bi-directional interface is made between the PV system AC output circuits and the primary electrical grid 104, typically at an on-site distribution panel or service entrance. This allows the AC power produced by the at least one PV array 101 to either supply on-site electrical loads, or to back-feed the microgrid 100 when the at least one PV array 101 output is greater than the on-site load demand. At night and during other periods when the electrical loads are greater than the at least one PV array 101 output, the balance of power required by the loads is received from the primary electrical grid 104. This safety feature is present in grid-connected PV systems and ensures that the PV system will not continue to operate and feed back into the primary electrical grid 104 when the microgrid 100 is down for service or repair.

In another embodiment of the system, the at least one PV array 101 can be a stand-alone PV array that is designed to operate independently of the primary electrical grid 104. A stand-alone PV array is generally designed and sized to supply certain DC and/or AC electrical loads. These types of systems may be powered by a PV array only, or may use wind, an engine-generator or utility power as an auxiliary power source in what is called a PV-hybrid system. The simplest type of stand-alone PV system is a direct-coupled system, where the DC output of a PV module or array is directly connected to a DC load. Generally, the load 112 only operates during sunlight hours, making these designs suitable for common applications such as ventilation fans, water pumps, and small circulation pumps for solar thermal water heating systems. Matching the impedance of the electrical load to the maximum power output of the at least one PV array 101 is included in the design of a well-performing direct-coupled system.

The parameters of the at least one battery 102 can vary from one embodiment to another. However, the at least one battery 102 is designed to ensure reliable power availability, grid stability, and highest possible penetration of renewable energy for both grid-connected mode and island mode. In one embodiment of the system, at least one lithium-ion (Li-ion) battery can be used. In another embodiment of the system, at least one zinc-hybrid battery can be used due to the lower material cost and wider availability of zinc versus the scarcer minerals needed for Li-ion batteries. However, other types of batteries that can be used include, but are not limited to, lead-acid, zinc-bromine, and aqueous hybrid ion. The size and capacity of the at least one battery 102 can vary from one embodiment to another.

The at least one generator 103, which is preferably a diesel generator, is the secondary power generation source for the microgrid 100 when the renewable energy generator (e.g., PV) cannot fulfill the required electricity demand. The conventional generator preferably serves as a backup energy source and improves the system reliability by smoothing the power generation from the renewable energy source. In addition to energy generation, the at least one generator 103 has two distinctive features: control, the most intelligent part, which predicts consumption and work cycles; and storage devices, the heart of a microgrid, which together with power electronics compensate for the load variations of renewables and are much more efficient in energy production. Even though only one generator is described in the present embodiment, more than one generator can be used in other embodiments of the system described in the present invention. The diesel generator used in the microgrid 100 may run as a continuous or prime generator and is preferably designed/sized to operate for significant durations at variable load. To be part of the microgrid 100, the diesel generator must respond to the requirements of reliability, rapid response time, fuel availability, and load supply capacity. Diesel generators are preferred in the microgrid 100 due to their size (from 1 kilovolt ampere (kVA) to more than 1000 kVA), initial cost, simplicity, and the accessibility to the ordinary fuel used.

The first control unit 105 comprises a buck converter 106 and a first voltage source converter (VSC) 107 and the at least one PV array 101 is electrically connected to the primary electrical grid 104 at the PCC 119 in grid-connected mode through the first control unit 105. The buck converter 106 is a DC to DC converter that steps down the voltage from the input to the output and the first VSC 107 generates AC voltage from an input DC voltage. The at least one battery 102, at the PCC 119 in grid-connected mode, is electrically connected to the primary electrical grid 104 through the second control unit 108 that comprises a second VSC 109. Both the first control unit 105 and the second control unit 108 are based on the decoupled d-q current control strategy, wherein the first VSC 107 comprises a first direct (d)-quadrature (q) controller and the second VSC 109 comprises a second d-q controller. The at least one generator 103 is electrically connected to the primary electrical grid 104 at the PCC 119 in grid-connected mode through the third control unit 110 which comprises a speed governing unit 111.

In reference to FIG. 1:

P_{PV} represents the power generated from the at least one PV array 101,

P_{BAT} is the charging and discharging power of the at least one battery 102,

P_{GEN} is the power generated from the at least one generator 103,

P_{LOAD} is the power drawn by the load 112,

P_{GRID} is the power exchanged between the primary electrical grid 104 and the microgrid 100,

Duty is the buck converter 106 control signal,

m_{D} and m_{Q} are the control signals to the first voltage source converter (VSC) 107 control signals,

m_{BD} and m_{BQ} are the control signals for the second VSC 109,

PCC is the point of common coupling 119,

CB is a circuit breaker from the plurality of circuit breakers 113.

The system and method of the present disclosure further comprise a plurality of circuit breakers 113, wherein the DERs are electrically connected to the primary electrical grid 104 through the plurality of circuit breakers 113. More specifically, the at least one PV array 101 when in grid-connected mode is connected to the primary electrical grid 104 at the PCC 119 through a first circuit breaker 114 selected from the plurality of circuit breakers 113. The at least one battery 102 in grid-connected mode is electrically coupled with the primary electrical grid 104 at the PCC 119 through a second circuit breaker 115 selected from the plurality of circuit breakers 113. The at least one generator 103 in grid-connected mode is electrically connected to the primary electrical grid 104 at the PCC 119 through a third circuit breaker 116 selected from the plurality of circuit breakers 113. The active load 112 when in grid-connected mode is also electrically connected to the primary electrical grid 104 at the PCC 119 through a load circuit breaker 117 selected from the plurality of circuit breakers 113. Moreover, the primary electrical grid 104 in grid-connected mode is connected to the microgrid 100 at the PCC 119 through a grid circuit breaker 118 selected from the plurality of circuit breakers 113. In island mode, each of the DERs, the at least one generator 103, and the primary electrical grid 104 are electrically coupled to the PCC 119 through the corresponding circuit breakers selected from the plurality of circuit breakers 113. The plurality of circuit breakers 113 can be, but is not limited to, mechanical circuit breakers and solid state circuit breakers, wherein the solid state circuit breakers are autonomously operated, programmable, and intelligent bidirectional. For simulation purposes, dynamic models of the system described in the present disclosure can be developed using simulation software such as RSCAD that utilize real-time digital power system simulator (RTDS) hardware. However, other comparable hardware and software can also be used for simulation purposes.

During grid-connected mode, when the microgrid 100 is connected to the primary electrical grid 104, the power required by the load 112 is supplied by both the DER and the primary electrical grid 104, wherein the voltage and the frequency are maintained at rated values determined by the primary electrical grid 104. In island mode, wherein the microgrid 100 operates in isolation from the primary electrical grid 104, the operating power for the load 112 is supplied by the DERs, wherein the voltage and the frequency are maintained by the diesel generator in isochronous mode. In the isochronous mode, the speed will return to the original speed set-point after a load has been applied or rejected. The frequency of the at least one generator 103 is managed by the speed governing unit 111 that maintains the frequency at a frequency of 60-Hertz (Hz).

As described earlier, each of the DERs is connected to the primary electrical grid 104 through a corresponding independent control unit. In particular, the at least one PV array 101 is connected to the primary electrical grid 104 through the first control unit 105, the at least one battery 102 is connected to the primary electrical grid 104 through the second control unit 108, and the at least one generator 103 is connected to the primary electrical grid 104 through the third control unit 110.

The buck converter 106, which is specifically a multistage topology buck converter 106, and the first VSC 107 are used to transfer the power generated from the at least one PV array 101, P_{PV}, to the PCC 119. In particular, an incremental conductance control method that is implemented in the buck converter 106 and the first d-q controller of the first VSC 107 are used to transfer the direct current (DC) link power to the PCC 119. The incremental conductance control method is beneficial in tracking the maximum power generated from the at least one PV array 101. The second d-q controller of the second control unit 108 is used to satisfy the charging and discharging objectives of the at least one battery 102. The at least one generator 103, which is controlled via the third control unit 110, supplies a constant active and reactive power during grid-connected mode wherein the primary electrical grid 104 manages the voltage and frequency. On the other hand, during island mode, the at least one generator 103 manages the voltage and frequency.

Different maximum power point tracking (MPPT) methods can be used to generate maximum power from the at least one PV array 101 under varying temperature and irradiation conditions. In a preferred embodiment of the system, incremental conductance is implemented to track the maximum power from the at least one PV array 101. In doing so, a PV array voltage, V_{PV}, is continuously adjusted under time varying temperature and irradiation conditions until a maximum power point (MPP) is reached. However, other comparable maximum power tracking methods that can be, but are not limited to, hill-climbing, perturbation and observation, fuzzy-logic, and neural network can be used in other embodiments. The system of the present disclosure further comprises at least one proportional integral (PI) controller that is used to force the at least one PV array 101 to function at MPP. To do so, the at least one PV array 101 is electrically connected to the buck converter 106 through the at least one PI controller. An error value between a MPPT output voltage, V_{ref}, is compared with the at least one PV array 101 voltage, V_{PV}, to generate a duty control signal for the buck converter 106. The duty control signal helps determine the output current capability of the buck converter 106.

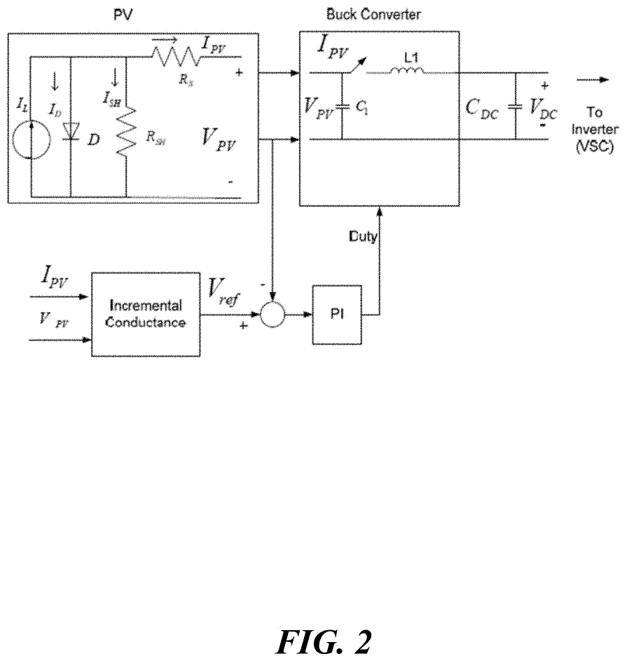

The circuit diagram corresponding to the MPPT method used with the at least one PV array 101 is represented in FIG. 2 and the duty control signal for the buck converter 106 is represented in equation 1.

$$Duty = ( {V}_{ref} - {V}_{PV} ) \cdot ( {k}_{PV} + \frac{{k}_{l}}{s} ) , \qquad ( 1 )$$

k_{P} and k_{I} are the proportional and integral constants of the at least one PI controller,

I_{PV} and V_{PV} are the PV array output current and voltage respectively,

V_{DC} is the DC link voltage,

V_{ref} is the MPPT output voltage.

Preferable parameters of the buck converter 106, the at least one PV array 101, and the specifications of the at least one battery 102 for a preferred embodiment are given in table 1.

TABLE 1
Photovoltaic (PV) panel, battery and other component parameters.

| | |
|---|---|
| Parameter | Value |

PV Array and Buck converter

| Reference Temperature | 25° | C. |
|---|---|---|
| Reference solar intensity | 1000 | W/m² |
| Series connected modules | 115 | |
| Parallel connected Modules | 66 | |
| Open circuit voltage | 21.7 | V |
| Voltage at maximum power (VMP) | 17.4 | V |
| Short Circuit current | 3.35 | A |
| Current at maximum power (IMP) | 3.05 | A |
| PV cells in each model | 36 | |
| Coupling inductance L₁ | 1.35 | mH |
| DC link capacitor C_{DC} | 80 | mF |
| C₁ | 10 | mF |
| Converter switching frequency | 5 | kHz |
| L₁ | 5 | mH |

Battery

| | | |
|---|---|---|
| capacity of a single cell | 0.85 | AH |

| | |
|---|---|
| Initial state of charge to a single cell | 85% |
| Number of cells in series in a stack | 350 |
| Number of stacks in parallel | 250 |
| Battery state of charge (SOC) | ≥50% |
| Capacity fading factor | 0% |

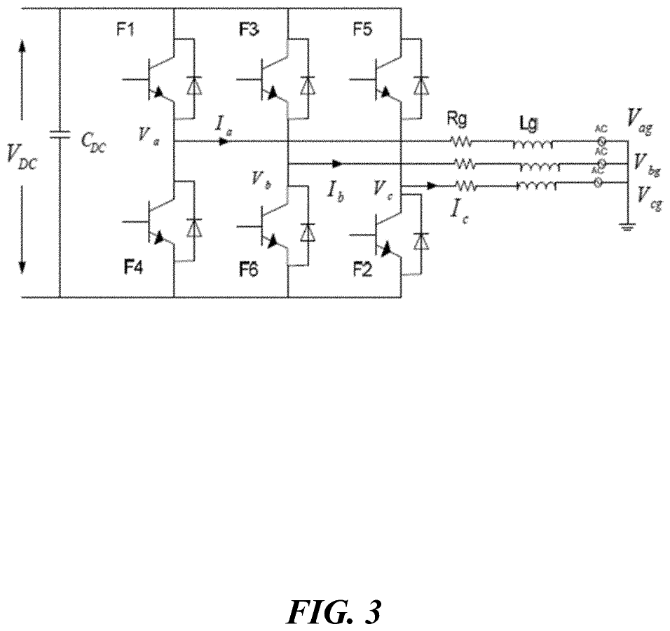

In addition to the buck converter 106 described earlier, the first control unit 105 also comprises the first VSC 107. When in use, the first VSC 107 integrates the at least one PV array 101 DC link power to the PCC 119 to supply alternating current (AC) loads and facilitates integration with the primary electrical grid 104. FIG. 3 is a circuit diagram used in the first VSC 107 where the corresponding three phase voltages can be expressed as:

$${RI}_{a} + L \frac{{dI}_{a}}{dt} = {V}_{a} - {V}_{ag} , \\ {RI}_{b} + L \frac{{dI}_{b}}{dt} = {V}_{b} - {V}_{bg} , \\ {RI}_{c} + L \frac{{dI}_{c}}{dt} = {V}_{c} - {V}_{cg} , \qquad ( 2 )$$

Where,

Iₐ, I_{b} and I_{c} are the line currents from the primary electrical grid,

Vₐ, V_{b}, V_{c} are the first VSC output voltages,

V_{ag}, V_{bg}, V_{cg} are the primary electrical grid voltages,

R_{g} and L_{g} are resistance and inductance of the line.

Utilizing the first d-q controller, a synchronous rotating reference frame (D-Q axis) based current control technique is implemented where the D current component, I_{LD}, controls the active power flow and the Q current component, I_{LQ}, controls the reactive power. The relationships listed in equation 3 are obtained based upon I_{LD} and I_{LQ}.

P_{DC}=P_{G}

P_{G}=3/2(V_{LD}I_{LD}+V_{LQ}I_{LQ}),

Q_{G}=3/2(V_{LQ}I_{LD}−V_{LD}I_{LQ}) (3)

Where,

P_{G} and Q_{G} are the active and reactive power of the primary electrical grid respectively,

P_{DC} is the DC link capacitor power,

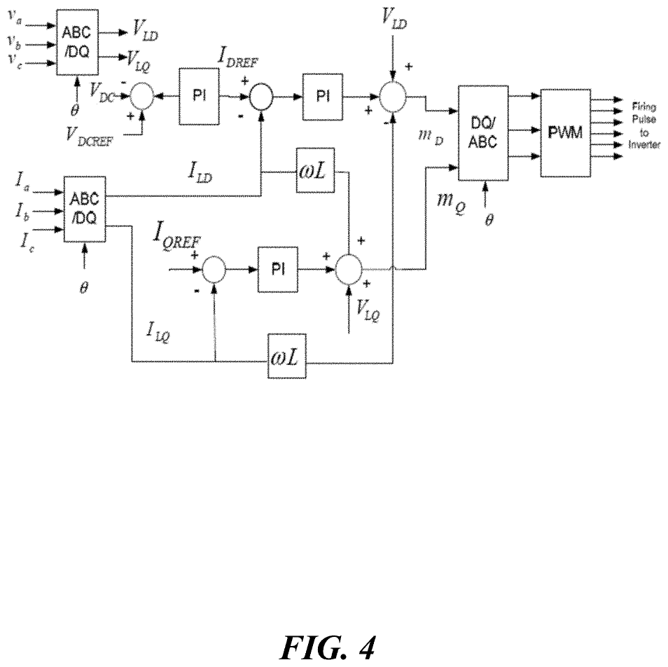

V_{LQ} and V_{LQ} are the D and Q axes voltage components and are shown in FIG. 4.

I_{LD} and I_{LQ} are the D and Q axes current components and are also shown in FIG. 4.

Equation 3 can be further reduced to equation 4 by aligning the D-axis reference frame to the phase voltage of the primary electrical grid (V_{LQ}=0).

P_{G}=3/2.

Q_{G}=3/2(V_{LQ}I_{LD}) (4)

To improve the performance of the at least one PI controller, feed forward voltage and cross-coupling terms are used as illustrated in FIG. 4. The resulting outer voltage control loop in the Laplace frame is given by equation 5.

$${I}_{DREF} ( {k}_{P 1 D} + \frac{{k}_{I 1 D}}{s} ) \cdot ( {V}_{DC} - {V}_{DCREF} ) . \qquad ( 5 )$$

The D-axis and Q-axis control signals in the Laplace domain are represented by equation 6 and equation 7.

$$\begin{matrix}{m}_{D} = ( {k}_{P 1 D} + \frac{{k}_{I 1 D}}{s} ) \cdot ( {I}_{DREF} - {I}_{LD} ) + {V}_{LD} - ω {LI}_{LQ} , & ( 6 ) \\ {m}_{D} = ( {k}_{P 2 D} + \frac{{k}_{I 2 D}}{s} ) \cdot ( {I}_{QREF} - {I}_{LQ} ) + {V}_{LQ} - ω {LI}_{LD} , & ( 7 )\end{matrix}$$

For equation 5 through equation 7:

kp's are the proportional constants,

k_{I's} are the integral constants,

m_{D}, and m_{Q} are the PV array D-axis and Q-axis control signals respectively.

Upon converting m_{D} and m_{Q} from a DQ frame to an ABC frame (DQ/ABC), pulse width modulation (PWM) is used to generate the firing pulses.

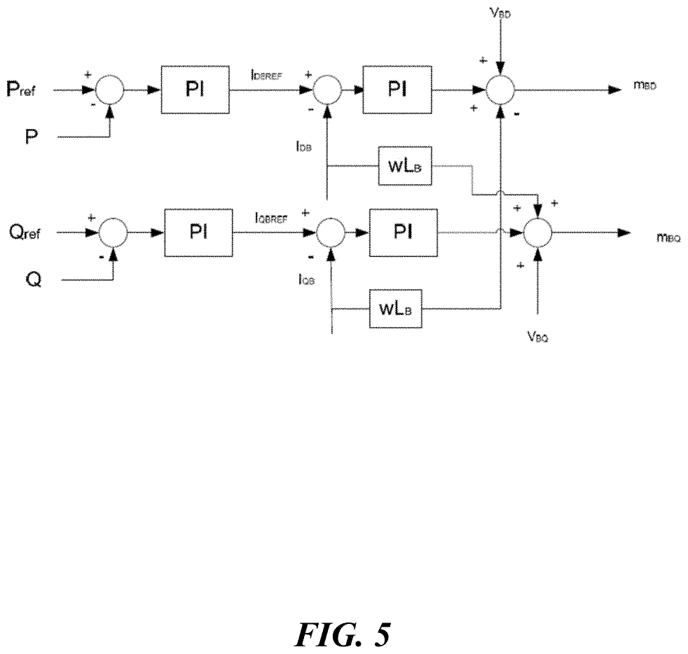

Similar to the first d-q controller being used to control the at least one PV array 101, the second d-q controller is used to control the at least one battery 102. More specifically, the at least one battery 102 is connected to the PCC 119 using the second VSC 109 that comprises the second d-q controller. During grid-connected mode, the at least one battery 102 is controlled as a constant P-Q control to inject a constant active and reactive power to the PCC 119. In island mode, the at least one battery 102 is controlled in a voltage control mode to support the required voltage and frequency. The second control unit 108 used to control the at least one battery 102 in grid-connected mode is illustrated in FIG. 5. During island mode, an outer control loop is replaced by a voltage control loop with a reference voltage equal to the PCC 119 voltage during the grid-connected mode. As listed in Table 1, in a preferred embodiment the parameters of the at least one battery 102 are as follows:

Capacity of a single cell: 0.85 ampere hours (AH)

Initial state of charge in a single cell: 85%

Number of cells in series in a stack: 250

Number of stacks in parallel: 250

Battery state of charge (SOC): ≥50%

Capacity fading factor: 0%

In other embodiments, the initial state of charge of a single cell, which represents the status of battery capacity can be, but is not limited to, being within a range of 15%-90%. The number of cells in a stack can vary according to application of the system and the overall expected system lifetime. For example, for an expected lifetime of 5.5 years, a stack used in residential applications can consist of 99 cells. On the other hand, for the expected lifetime of 5.5 years, a stack used in commercial applications can consist of 325 cells. In another instance, for the same expected lifetime, a stack used in industrial applications can consist of 379 cells.

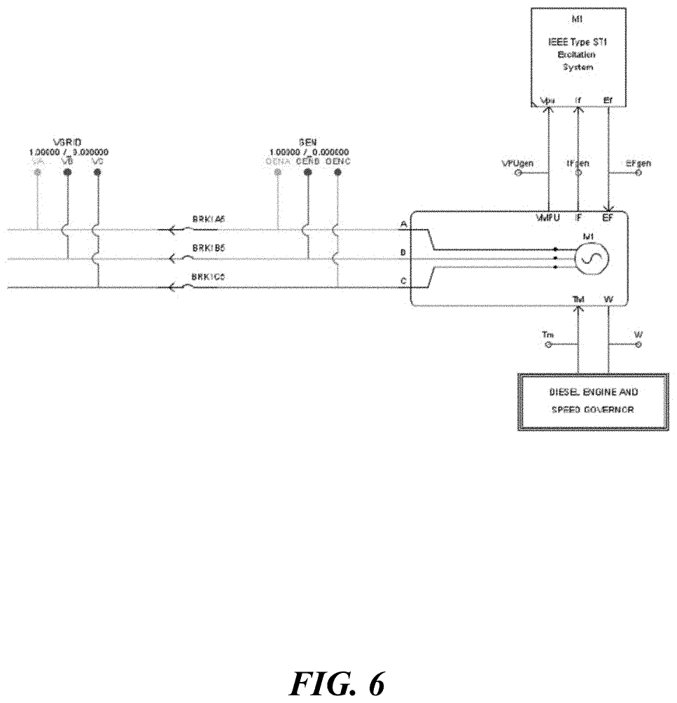

In grid-connected mode, the at least one generator 103 provides real and reactive power. On the other hand, in island mode, the at least one generator 103 regulates the microgrid 100 frequency as illustrated in FIG. 6. The speed governing unit 111 of the third control unit 110 and the at least one generator 103, which is preferably a synchronous generator with an excitation unit, is used to fulfill the functionalities of the at least one generator 103 in both grid-connected mode and island mode. By using a synchronous generator, mechanical power is converted into an AC electrical power at a preferred voltage and frequency. The speed governing unit 111 ensures that the at least one generator 103 operates at a synchronous speed which is constant. The excitation unit, which provides field current to the rotor winding of the at least one generator 103, is designed to provide reliability of operation, stability, and fast transient response. Excitation units for synchronous generators may be classified in terms of construction in two categories: static and rotating excitation systems. Static excitation systems consist of a thyristor or a transistor bridge and a transformer. Energy needed for excitation is brought to the at least one generator 103 field winding via slip-rings with carbon brushes from diodes, thyristors or transistor bridge, and transformer.

Separate excitation systems may be static or brushless. These systems are independent of disruptions and faults that occur in electric power system, and have possibility to force excitation.

Brushless systems are used for excitation of larger generators (power over 600 MVA) and in flammable and explosive environments. Brushless system consists of AC exciter, rotating diode bridge and an auxiliary AC generator realized with permanent magnet excitation. Attempts to build brushless system with a thyristor bridge were not successful due to thyristor control reliability. Thus, a significant disadvantage of these systems was the inability of generator to execute de-excitation. Another disadvantage is slower response of system, especially in cases of low excitation. Self-excitation systems have advantages that can be, but is not limited to, simplicity and low costs. Generally, a thyristor or transistor bridge is electrically coupled to the at least one generator 103 terminals via transformer. The main disadvantage is that the excitation supply voltage, and thereby excitation current, depends directly on generator output voltage. Brushless self-excitation systems with diode bridge also exist and can be used in other embodiments of the system of the present disclosure.

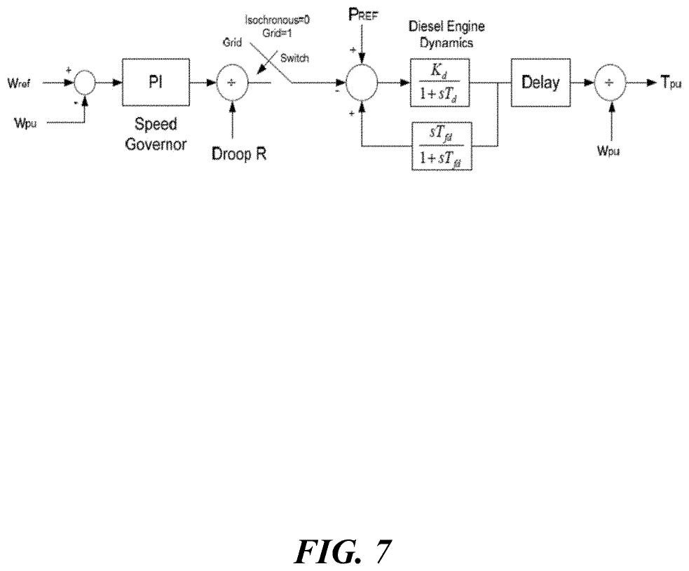

FIG. 7 is an electrical diagram showing the at least one generator 103, which is a diesel generator, and the speed governing unit 111. The inputs to the at least one generator 103 are per unit speed w and per unit speed reference w_{ref}. An output of the speed governing unit 111 gives a per unit mechanical torque Tₚᵤ which drives the shaft of the synchronous generator. In grid-connected mode, the at least one generator 103 supplies specific reference power in a droop speed control mode, wherein the droop speed control mode controls a prime mover driving the synchronous generator. However, to control and maintain a constant frequency under varying load conditions that occur in island mode, the at least one generator 103 is operated in isochronous mode where the speed of the prime mover returns to original speed after a load has been applied or rejected. The parameters of the at least one generator 103 are given in table 2.

TABLE 2
Diesel generator paramaters.

| Parameter | Value | |
|---|---|---|
| Rated rms line to line voltage | 0.48 | kV |
| Rated MVA of the machine | 1.25 | MVA |
| Inertia constant | 1.7 | |
| Stator resistance | 0.002 | pu |
| Leakage reactance, Stator | 0.13 | pu |
| Unsaturated reactance, d-axis | 1.7 | pu |
| Unsaturated transient reactance, d-axis | 0.16 | pu |
| Unsaturated sub-trans reactance, d-axis | 0.135 | pu |
| Unsaturated transient open T constant, d-axis | 4.3 | s |
| Unsaturated sub-transient open T constant, d-axis | 0.032 | s |
| Unsaturated reactance, q-axis | 1.71 | pu |
| Unsaturated transient reactance, q-axis | 0.228 | pu |
| Unsaturated sub-trans reactance, q-axis | 0.2 | pu |
| Unsaturated transient open T constant, q-axis | 0.85 | s |
| Unsaturated sub-transient open T constant, q-axis | 0.05 | s |
| Grid voltage | 0.48 | kV |

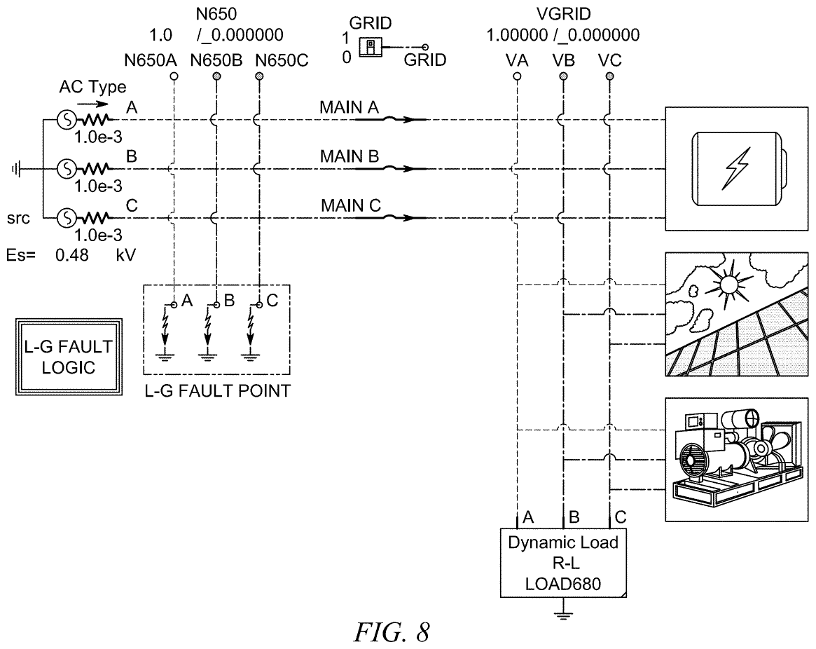

When the system of the present disclosure was simulated through RTDS simulation hardware as shown in FIG. 8. The parameters for the at least one PV array 101 and the at least one generator 103 were selected as listed in table 1 and table 2. As listed in table 1, in a preferred embodiment the solar intensity of the at least one PV array 101 is 1000 Watt (W)/square meter (m²) and 25° C. However, the temperature can vary between 20° C.-30° C. in other embodiments and the intensity levels will vary accordingly. For example, at 20° C. the intensity will be 800 W/m². In a preferred embodiment, the voltage at maximum power (VMP) at MMP is 2001Volts (V) (=115*17.4V) and the current at maximum power (IMP) at MMP is 201.3 Amperes (A) (=66*3.05 A). Thus, at MMP 402.8 kilowatt (kW) (2001V*201.3 A) is the expected power from the at least one PV array 101. However, in a different embodiment when different parameters are selected, a different power can be expected from the at least one PV array 101. The buck converter 106 that is electrically connected to the at least one PV array 101 converts the PV array terminal voltage (2 kilovolts (kV)) to 1.62 kV as a common DC link voltage which is an input to the first VSC 107 to be converted to AC. However, in other embodiments, the buck converter can be designed to convert the PV array voltage to a voltage which can be lesser than or greater than 1.62 kV.

In order to demonstrate the effectiveness, the system of the present disclosure was tested in grid-connected mode, island mode, and fault ride-through conditions. In grid-connected mode, the system of the present disclosure was tested by varying the load, irradiation, and charging/discharging set points of the at least one battery 102. In island mode, the system of the present disclosure was tested by varying the at least one PV array 101 irradiation, battery, and load set points. In fault ride-through conditions, the capability of the at least one generator 103 to maintain a specific frequency after a three phase fault was tested.

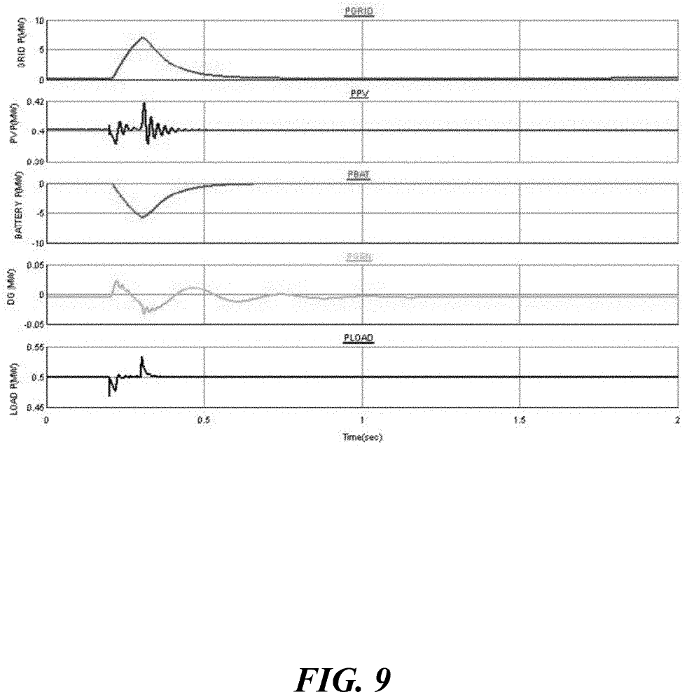

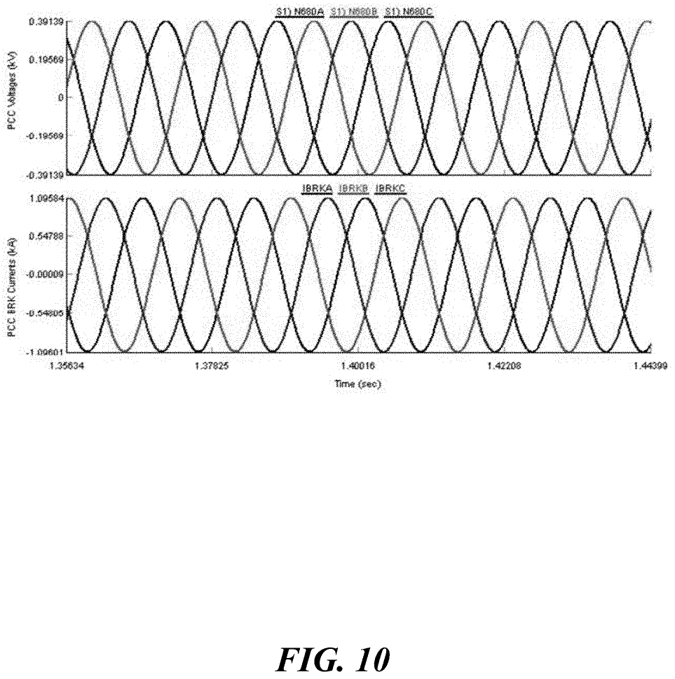

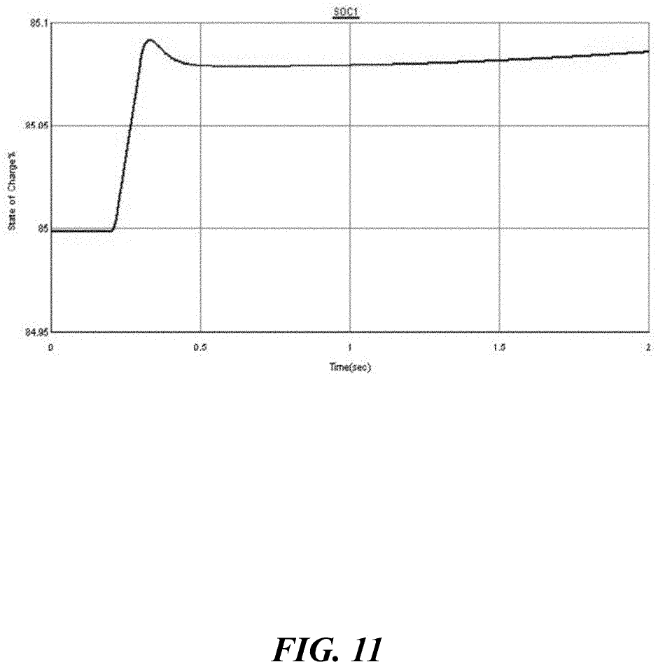

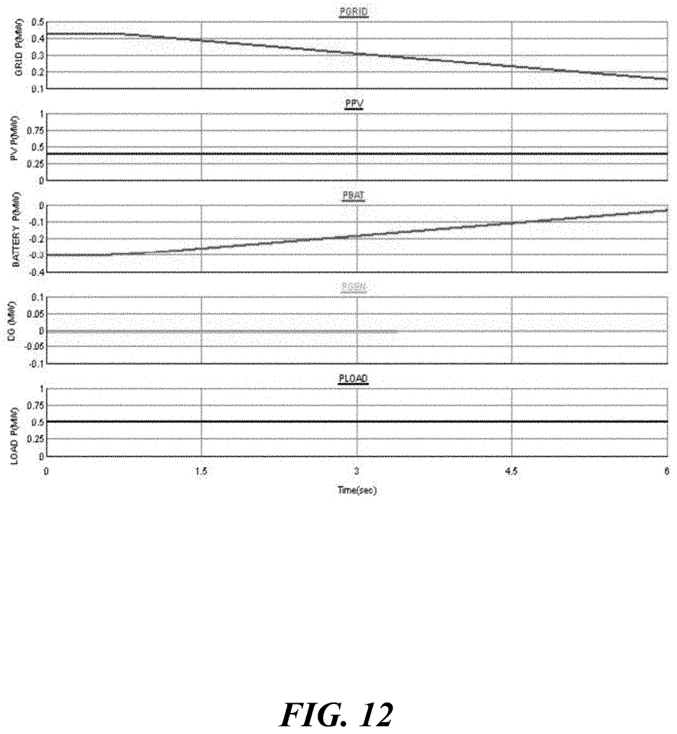

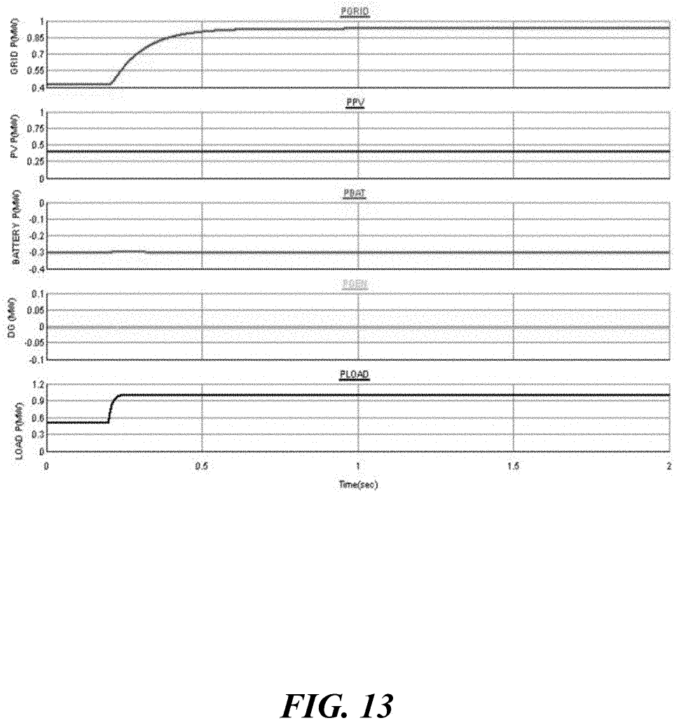

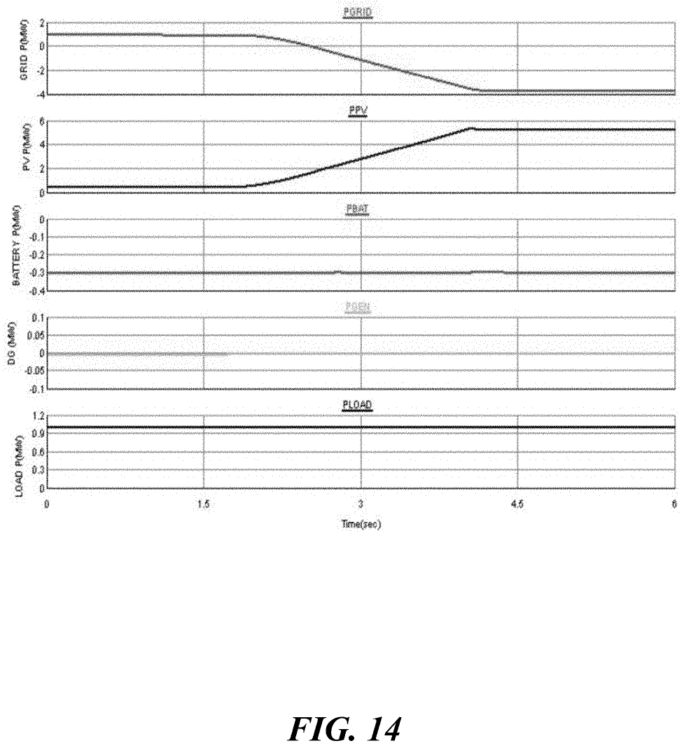

In grid-connected mode, wherein the system of the present disclosure is in normal operation, both the microgrid 100 and the primary electrical grid 104 operate in parallel. When a control switch corresponding to each DER is on, the power required by the load 112 is supplied by both the primary electrical grid 104 and the DER. A reference load power is set to 0.5 megawatt (MW) and the irradiation of the at least one PV array 101 is set to 1000 W/m² such that the at least one PV array 101 generates approximately 0.4 MW. Moreover, in grid-connected mode in a preferred embodiment, the at least one battery 102 is being charged with a reference power set point of 0.3 MW. In this instance, the power from the at least one PV array 101 charges the at least one battery 102 and the remaining power is supplied to the load 112. To transfer power from the at least one PV array 101 to the at least one battery 102, the at least one PV array 101, the at least one battery 102, and the at least one generator 103 are electrically connected to each other. The remaining power required by the load 112 is supplied by the primary electrical grid 104 and thus, the at least one generator 103 does not generate any output power to supply the load 112. FIG. 9 is an illustration comparing the power from the primary electrical grid 104 P_{GRID}, the power from the at least one PV array 101 P_{PV}, the power from the at least one battery 102 P_{BAT}, the at least one generator 103 P_{GEN}, and the load 112 power P_{LOAD}. As observed, the at least one PV array 101 generates the maximum available power to charge the at least one battery 102 and the system of the present disclosure manages the power balance with the primary electrical grid 104 such that the power demand of the load 112 is satisfied. The corresponding PCC 119 voltage is kept at a rated value as shown in FIG. 10. FIG. 11 is a graph illustrating the state of charge (SOC) of the at least one battery 102. If the at least one battery 102 gets discharged, wherein the reference power is 0.3 MW, the power of the primary electrical grid 104 decreases by the same amount as seen in FIG. 12. On the other hand, if the power required by the load 112 increased from 0.5 MW to 1 MW, the power supplied by the primary electrical grid 104 increases to accommodate the difference as seen in FIG. 13. On the other hand, if the irradiation increases from 1000 W/m² to 1200 W/m², the power supplied from the primary electrical grid 104 decreases accordingly as seen in FIG. 14. The simulation results also show that the at least one generator 103 supplies approximately the maximum active power and zero reactive power since the system is designed to operate at unity power during normal operation.

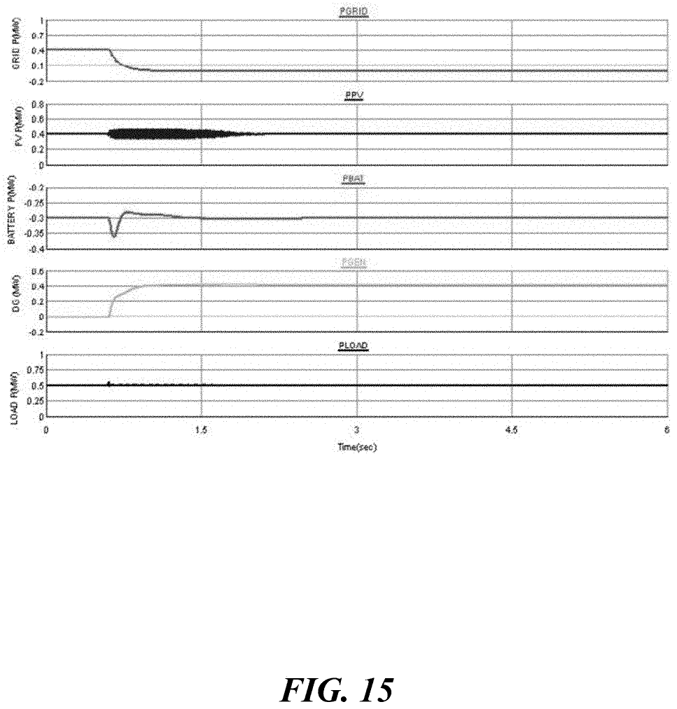

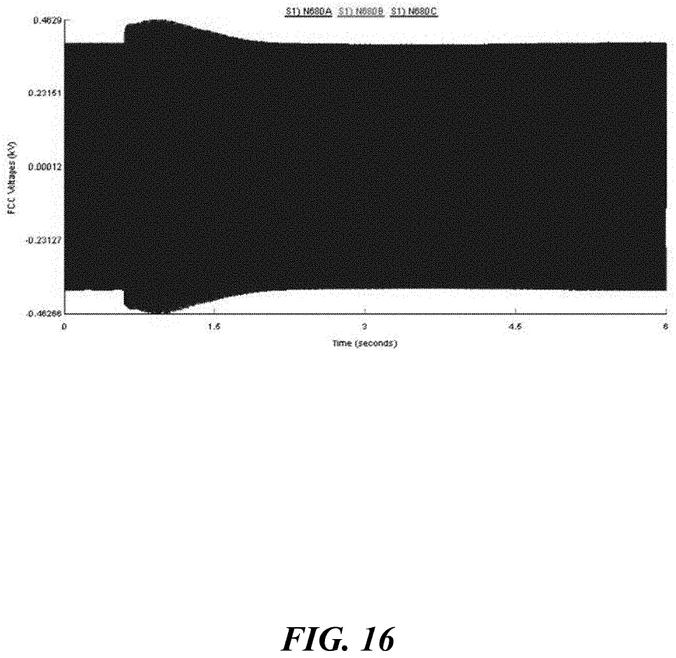

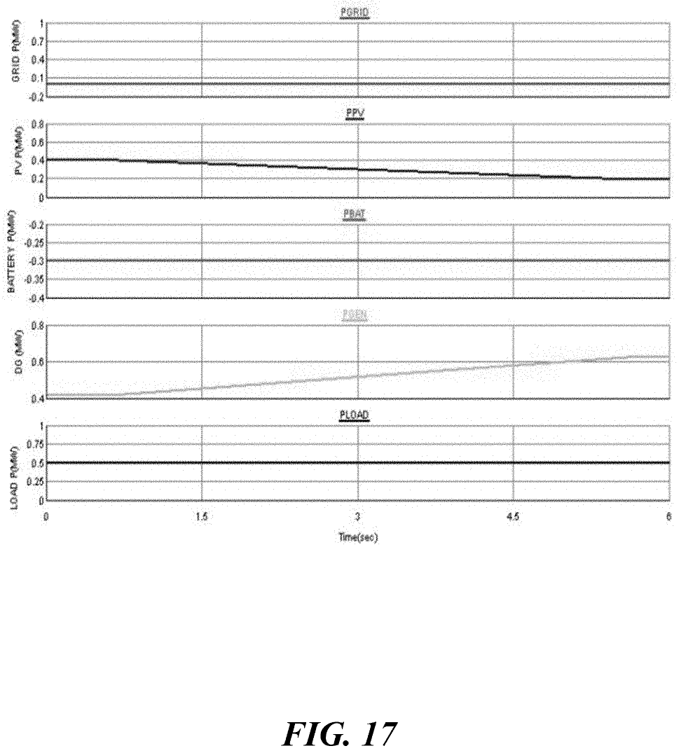

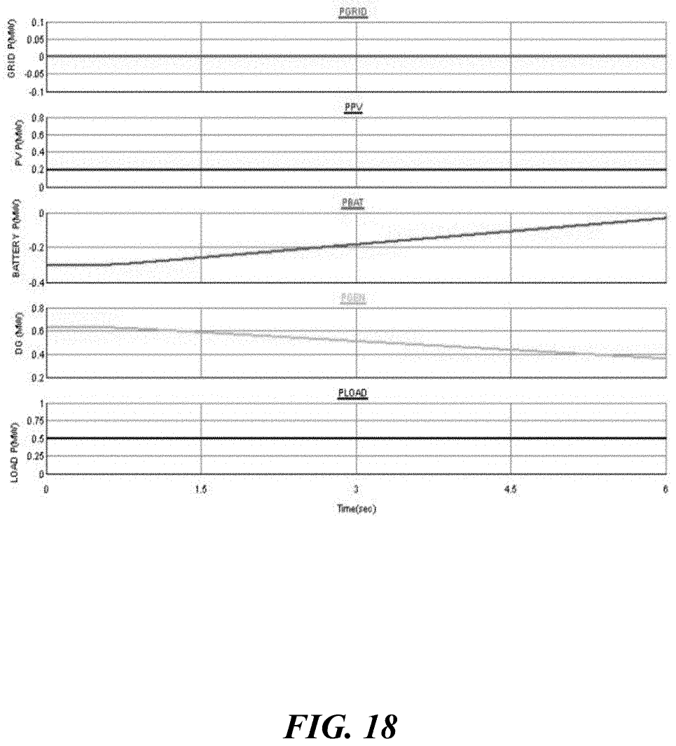

As described earlier, the system of the present disclosure was also tested in island mode. To convert the system from the grid-connected mode to the island mode, the grid circuit breaker 118 is turned off, wherein in grid-connected mode the system was operating with irradiation of 1000 W/m² and the at least one battery 102 was being charged with P_{REF}=−0.3 MW. When in island mode, the at least one generator 103 matches the power supplied by the primary electrical grid 104 and balances the power demand of the load 112. As seen in FIG. 15, the load 112 demand is completely supplied by the DER since the power from the primary electrical grid 104 is reduced to zero. As seen in FIG. 16, the corresponding PCC 119 voltage is maintained at a rated value. In another instance, when the at least one PV array 101 irradiation is decreased from 1000 W/m² to 500 W/m², the at least one generator 103 increases the generated power to accommodate the difference as shown in FIG. 17. In similar circumstances, if the at least one battery 102 discharges (from −0.3 to 0.3) the at least one generator 103 power decreases as illustrated in FIG. 18. More specifically, the at least one battery 102 has the ability to discharge in island mode to fulfill the voltage requirements of the active load 112.

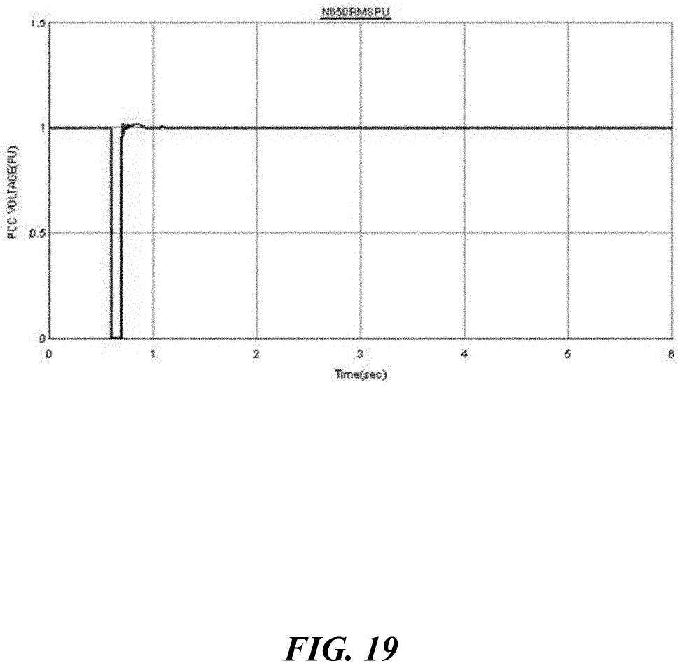

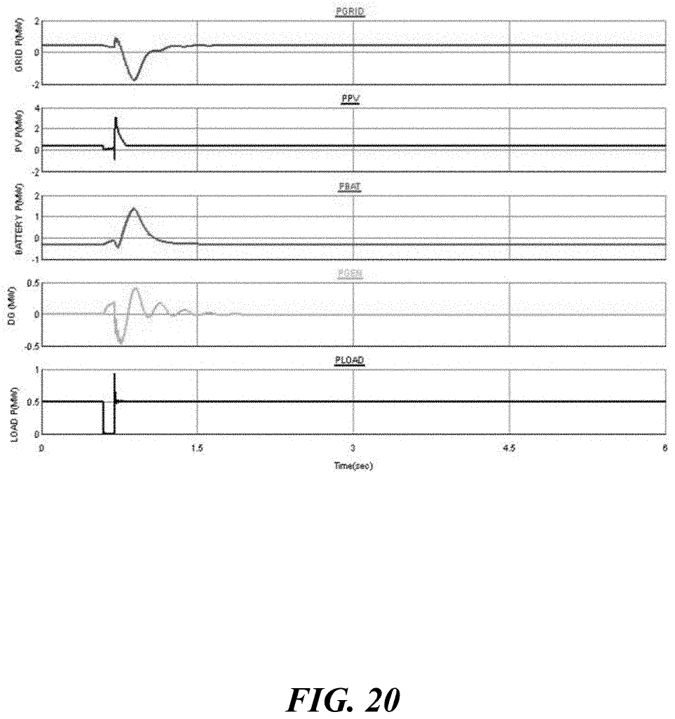

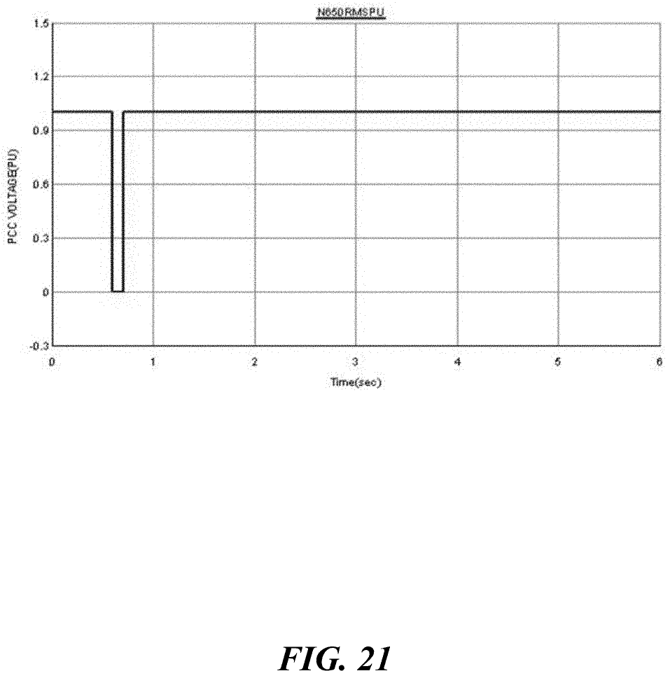

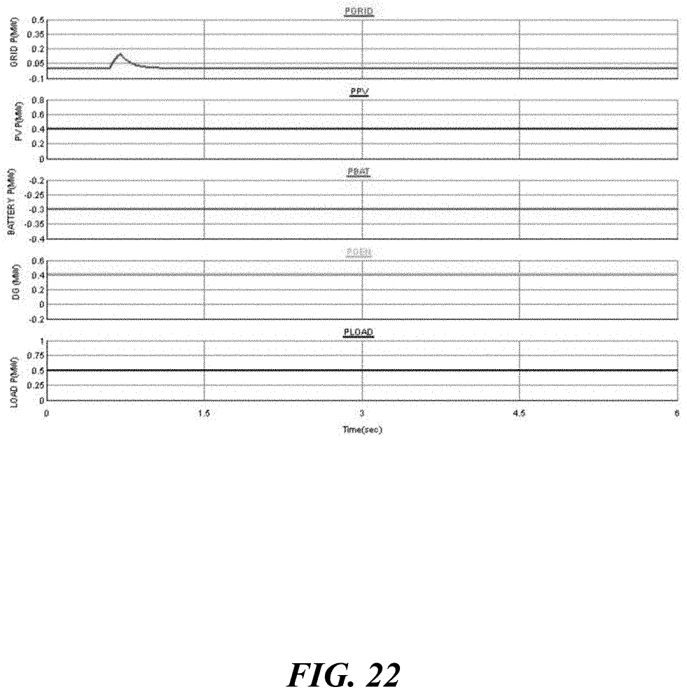

In order to test the robustness of the system of the present disclosure, a three phase fault of six cycles was applied during both the grid-connected mode and the island mode. As seen in FIG. 19, the PCC 119 voltage shows that the system functioned through the fault. FIG. 20 shows the power values from the primary electrical grid 104, the at least one PV array 101, the at least one battery 102, the at least one generator 103, and the load 112 during the grid fault. The response of the system of the present disclosure to a six cycle fault in island mode is shown in FIG. 21 and FIG. 22. From the results obtained, it is clear that the system described in the present disclosure has recovered from faults and that the at least one battery 102 energy storage system helps the microgrid 100 ride through the fault.

The present disclosure describes a power management control scheme and method for a microgrid 100 based on at least one PV array 101, at least one battery 102, at least one generator 103, and a load 112. An independent P-Q controller, wherein the output from the P-Q controller is a d-q component of current, is implemented to transfer power from the at least one PV array 101 and the at least one battery 102 to both the PCC 119 and to the load 112. The incremental conductance based MPPT method forces the at least one PV array 101 to work at the maximum power. The system voltage and frequency are maintained at a rated value by the primary electrical grid 104 during grid-connected mode and by the at least one generator 103 in the island mode. The transient and steady state response of the microgrid 100 for both grid-connected and island modes of operation have shown to give satisfactory performance. Moreover, with the energy storage approach, the fault ride-through capabilities were improved. The experimental results associated with the system of the present disclosure provide substantial evidence that the system of the present disclosure manages the power required by the load 112 during both grid-connected mode and island mode and thus, is improved in reliability in comparison to the conventional systems and methods.

Terminology used herein is for the purpose of describing particular embodiments only and is not intended to be limiting of the invention.

The headings (such as “Background” and “Summary”) and sub-headings used herein are intended only for general organization of topics within the present invention, and are not intended to limit the disclosure of the present invention or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “and/or” includes any and all combinations of one or more of the associated listed items and may be abbreviated as “/”.

Links are disabled by deletion of http: or by insertion of a space or underlined space before www. In some instances, the text available via the link on the “last accessed” date may be incorporated by reference.

As used herein in the specification and claims, including as used in the examples and unless otherwise expressly specified, all numbers may be read as if prefaced by the word “substantially”, “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), +/−20% of the stated value (or range of values), etc. Any numerical range recited herein is intended to include all subranges subsumed therein.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10 it also describes subranges for Parameter X including 1-9, 1-8, 1-7, 2-9, 2-8, 2-7, 3-9, 3-8, 3-7, 2-8, 3-7, 4-6, or 7-10, 8-10 or 9-10 as mere examples. A range encompasses its endpoints as well as values inside of an endpoint, for example, the range 0-5 includes 0, >0, 1, 2, 3, 4, <5 and 5.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present invention that do not contain those elements or features.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Spatially relative terms, such as “under”, “below”, “lower”, “over”, “upper”, “in front of” or “behind” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

All publications and patent applications mentioned in this specification are herein incorporated by reference in their entirety to the same extent as if each individual publication or patent application was specifically and individually indicated to be incorporated by reference, especially referenced is disclosure appearing in the same sentence, paragraph, page or section of the specification in which the incorporation by reference appears.

The citation of references herein does not constitute an admission that those references are prior art or have any relevance to the patentability of the technology disclosed herein. Any discussion of the content of references cited is intended merely to provide a general summary of assertions made by the authors of the references, and does not constitute an admission as to the accuracy of the content of such references.

Obviously, numerous modifications and variations of the present invention are possible in light of the above teachings. It is therefore to be understood that within the scope of the appended claims, the invention may be practiced otherwise than as specifically described herein.

1. A power management and control system for an electric grid, comprising:
a microgrid, wherein the microgrid is an active load based microgrid;
a primary electrical grid;
a first control unit, wherein the first control unit comprises a buck converter and a first voltage source converter (VSC);
a second control unit, wherein the second control unit comprises a second VSC;
a third control unit, wherein the third control unit comprises a speed governing unit;
the microgrid comprises at least one photovoltaic (PV) array, at least one battery, and at least one generator;
the at least one PV array, the at least one battery, and the at least one generator being electrically connected to each other;
the microgrid and the primary electrical grid being electrically coupled at a point of common coupling (PCC);
the at least one PV array being electrically connected to the PCC through the first control unit;
the at least one battery being electrically connected to the PCC through the second control unit;
the at least one generator being electrically connected to the PCC through the third control unit;
the microgrid and the primary electrical grid being electrically connected to the active load, wherein the microgrid is in a grid-connected mode; and
the microgrid being electrically connected to the active load, wherein the microgrid is in island mode.

2. The power management and control system for an electric grid as of claim 1 further comprising:
a plurality of circuit breakers;
the at least one PV array being electrically connected to the PCC through a first circuit breaker selected from the plurality of circuit breakers;
the at least one battery being electrically coupled to the PCC through a second circuit breaker selected from the plurality of circuit breakers;
the at least one generator being electrically connected to the PCC through a third circuit breaker selected from the plurality of circuit breakers;
the active load being electrically connected to the PCC through a load circuit breaker selected from the plurality of circuit breakers; and
the primary electrical grid being connected to the PCC through a grid circuit breaker selected from the plurality of circuit breakers.

3. The power management and control system for an electric grid as of claim 1, wherein the buck converter comprises an incremental conductance control unit.

4. The power management and control system for an electric grid as of claim 1, wherein a frequency of the at least one generator is controlled through the speed governing unit.

5. The power management and control system for an electric grid as of claim 1, wherein a frequency of the at least one generator is maintained at 60-Hertz (Hz).

6. The power management and control system for an electric grid as of claim 1, wherein the buck converter is a multistage topology based buck converter.

7. The power management and control system for an electric grid of claim 1, wherein an incremental conductance control method is implemented for the buck converter.

8. The power management and control system for an electric grid as of claim 1, wherein the first VSC comprises a first direct (d)-quadrature (q) controller.

9. The power management and control system for an electric grid as of claim 1, wherein the second VSC comprises a second d-q controller.

10. The power management and control system for an electric grid as of claim 1 further comprising:
at least one proportional integral (PI) controller; and
the at least one PV array being electrically connected to the buck converter through the at least one PI controller.

11. The power management and control system for an electric grid as of claim 1, wherein the at least one generator is a synchronous generator comprising an excitation unit.

12. The power management and control system for an electric grid as of claim 1, wherein the at least one generator is in a droop speed control mode in a grid-connected mode.

13. The power management and control system for an electric grid as of claim 1, wherein the at least one generator is in an isochronous mode in an island mode.

14. The power management and control system for an electric grid as of claim 1, wherein the at least one generator is a diesel generator.

15. The power management and control system for an electric grid as of claim 1, wherein a solar intensity of the at least one PV array is 1000 W/m² and a temperature of the PV array is 25° C.

16. A method of power management and control for a renewable energy based microgrid, comprising:
wherein a microgrid is electrically coupled to a primary electrical grid at a point of common coupling,
wherein the microgrid is an active load based microgrid,
wherein the microgrid comprises at least one photovoltaic (PV) array, at least one battery, and at least one generator;
determining a power demand for the active load;
supplying the power demand, in grid-connected mode, through the microgrid and the primary electrical grid, wherein a voltage and a frequency of the power demand is controlled by the primary electrical grid; and
supplying the power demand, in island mode, through the microgrid, wherein the voltage and the frequency of the power demand is controlled by the at least one generator.

17. The method of power management and control for a renewable energy based microgrid as of claim 16, wherein the at least one PV array, the at least one battery, the at least one generator, the active load, and the primary electrical grid are connected to the PCC through a corresponding circuit breaker.

18. The method of power management and control for a renewable energy based microgrid as of claim 16, wherein the at least one PV array, the at least one battery, the at least one generator are connected to the PCC through a corresponding control unit.

19. The method of power management and control for a renewable energy based microgrid as of claim 16, wherein the at least one battery is charged in grid-connected mode and is used as a fault ride-through for the microgrid.

20. The method of power management and control for a renewable energy based microgrid as of claim 16, wherein the at least one battery is discharged in island mode and is used as a fault ride-through for the microgrid.
